(19) United States
(12) Patent Application Publication
(10) Pub. No.: US 2024/0391831 A1
(43) Pub. Date: Nov. 28, 2024

(54) DRY GRINDING OF MINERAL MATERIALS, GROUND MINERAL MATERIALS, AND THEIR USE IN CONSTRUCTION MATERIALS

(71) Applicant: SIKA TECHNOLOGY AG, Baar (CH)

(72) Inventors: Thomas HELLER, Meckesheim (DE); Thomas MÜLLER, Sandhausen (DE); Johannes UNSELD, Clausthal-Zellerfeld (DE)

(73) Assignee: SIKA TECHNOLOGY AG, Baar (CH)

(21) Appl. No.: 18/688,985

(22) PCT Filed: Jun. 10, 2022
(86) PCT No.: PCT/EP2022/065897

§ 371 Date: Mar. 4, 2024

(30) Foreign Application Priority Data
Sep. 7, 2021 (EP) 21195310.4

(51) Int. Cl. C04B 20/02; C04B 14/28; C04B 24/02; C04B 24/12; C04B 28/04; C04B 40/00

(52) U.S. Cl. CPC C04B 20/026; C04B 14/28; C04B 24/023; C04B 24/122; C04B 28/04; C04B 40/0042

(57) ABSTRACT

The use of a grinding additive during the dry grinding of mineral materials, especially limestone, characterized in that the grinding additive is selected from the group made of alkanolamines, glycols, glycerol, sugars, sugar acids, carboxylic acids or their salts, superplasticizers, superabsorbent polymers, or mixtures thereof. Also, ground mineral materials, especially ground limestone, including the additives and the use of the ground mineral materials, especially ground limestone, in cement and/or construction materials.

### TECHNICAL FIELD

The present invention relates to the dry grinding of mineral materials in the presence of grinding additives selected from alkanolamines, glycols, glycerol, sugars, sugar acids, carboxylic acids or their salts, superplasticizers, superabsorbent polymers, or mixtures thereof. The present invention also relates to ground mineral materials comprising said additives and their use in construction materials.

### BACKGROUND

Cement-based building materials, especially concrete or mortars, rely on cementitious materials as binders. Cementitious binders typically are hydraulic binders the most abundant of which are cements and especially Ordinary Portland Cement. However, the use of cements and especially of Ordinary Portland Cement has a high environmental footprint. One major reason are the high CO₂ emissions associated with the manufacture of cements. Many efforts have thus been made to at least partially replace cements as binders from building materials.

One possibility is the use of materials with cementitious properties, pozzolanes, latent hydraulic materials, and/or inert materials as cement replacement. An especially appealing material of this kind is limestone as it is naturally available in large quantities.

Limestone is known to be used as a supplementary cementitious material, for example in cements of type CEM II/A, CEM II/B, and CEM II/C according to standard EN 197-1. Limestone is present in cements of type CEM II/B-L and CEM II/B-LL in up to 35 w %.

Raw mineral materials, and also raw limestone, typically needs to be ground in a compressive grinder or an attrition mill to obtain a powder product with a fineness suitable to be used in construction materials. Possible ways of grinding a mineral material are by the use of a vertical roller mill or a ball mill. In a vertical roller mill, a compressive force on the mineral material's particles is exerted by rotating cylinders while in a ball mill the impact of balls on the particles leads to their disintegration. In any case a powder with defined fineness can be obtained. The grinding can be done in a dry state or in a wet state, e.g. where the mineral material is suspended in water.

Dry grinding of mineral materials can be advantageous over wet grinding because the resulting ground mineral materials do not need to be additionally dried before being formulated for example in dry mortars.

It is well known in the art of grinding of cement and other mineral materials that various grinding additives can be used during grinding to improve the overall efficiency of the grinding process.

EP 2132268 discloses a method for the dry grinding of a material comprising a calcium carbonate, which can be limestone, in the presence of comb polymers as grinding additives.

EP 2660217 describes the grinding of an inorganic solid selected from cement clinker, pozzolane and/or raw material for cement production where a grinding additive comprising caprolactam and aminocaproic acid is used.

However, the grinding efficiency and the suitability of ground materials obtained may still be improved. There is thus still a need for improved methods of grinding mineral materials and especially limestone. Specifically, the dry grinding of mineral materials and especially of limestone needs to be improved.

### SUMMARY OF THE INVENTION

It is the objective of the present invention to provide methods for the dry grinding of mineral materials, especially limestone. Especially, the efficiency of the dry grinding of mineral materials, especially limestone, is to be improved. It is also an object of the present invention to provide improved ground mineral materials, especially ground limestone, which can be used to make construction materials. Finally, the present invention also aims at providing improved construction materials comprising ground mineral materials, especially ground limestone.

Surprisingly, it has been found that the objectives of the present invention can be solved by the subject-matter of the independent claims.

Especially, the use of grinding additives selected from alkanolamines, glycols, glycerol, sugars, sugar acids, carboxylic acids or their salts, superplasticizers, superabsorbent polymers, or mixtures thereof, in the dry grinding of mineral materials, especially limestone, leads to an improvement in grinding efficiency and to improved ground mineral materials, especially limestone comprising these additives.

The efficiency of the dry grinding of mineral materials, especially limestone, can be improved by the use of said additives. In particular, a higher fineness can be obtained. Specifically, a higher Blaine surface and/or lower sieve residue on a given sieve of ground mineral materials, especially limestone, is obtained when grinding is effected for the same time with said additives being present as compared to when no additives are present. Alternatively, the same Blaine surface of ground mineral materials, especially limestone, can be obtained in a shorter grinding time when grinding is done with said additives being present as compared to when no additives are present.

It is also possible, by uses and methods according to the present invention to improve the particle size distribution of ground mineral materials, especially ground limestone in continuous grinding processes. An improvement of the particle size distribution in this context especially is a reduction of very small particles.

Additionally, the amount of ground mineral materials, especially limestone, sticking to grinding tools (e.g. balls and vessel of a ball mill) is significantly reduced when additives of the present invention are used.

It has also surprisingly been found that the use of a mineral materials, especially limestone dry ground in the presence of a grinding additive of the present invention improves the performance of a cement and/or of a construction material comprising said mineral materials, especially limestone, as compared to the same cement and/or construction material comprising a mineral materials, especially limestone ground without said additives. Especially the early strength of the construction material is improved when a limestone dry ground in the presence of a grinding additive of the present invention is used.

Other aspects of the present invention are the subject of independent claims. Preferred embodiments of the present invention are the subject of dependent claims.

### WAYS OF CARRYING OUT THE INVENTION

Within the present context the terms milling and grinding have the same meaning and can be exchanged.

In a first aspect the present invention relates to the use of a grinding additive during the dry grinding of mineral materials, especially limestone, characterized in that the grinding additive is selected from the group consisting of alkanolamines, glycols, glycerol, sugars, sugar acids, carboxylic acids or their salts, superplasticizers, superabsorbent polymers, or mixtures thereof.

A mineral material within the present context is any naturally occurring magmatic, metamorphic or sedimentary rock. Examples of a mineral material include sandstone, limestone, marl, slit, oil shale, granite, slate, marble, gneiss, feldspar, granite, and basalt. Within the present context, mineral materials do not encompass cements, slags, and/or clay minerals.

An especially preferred mineral material within the present context is limestone. Limestone, within the present context, relates to a carbonate sedimentary rock mainly composed of calcium carbonate. The term limestone, within the present context, also encompasses the minerals calcite and aragonite, chalk, as well as the mineral dolomite. Thus, the term limestone presently refers to CaCO₃ as well as CaMg(CO₃)₂ or mixtures thereof. Limestone within the present context, is a naturally occurring material and may contain impurities. Common impurities are for example clay minerals. It is, however, preferred that a limestone of the present invention consists to at least 60 w %, preferably at least 70 w %, more preferably at least 80 w %, still more preferably at least 90 w %, especially at least 98 w % of CaCO₃ and/or CaMg(CO₃)₂.

The particle size of mineral materials, especially limestone, can be analyzed by sieve analysis as described for example in standard ASTM C136/C136M. The process separates fine particles from more course particles by passing the material through a number of sieves of different mesh sizes. The material to be analysed is vibrated through a series of sequentially decreasing sieves using a single, or combination of horizontal, vertical, or rotational motion. As a result, the percentage of particles retained on a sieve of a given size is indicated.

Alternatively, particle sizes of mineral materials, especially limestone, can be measured by laser diffraction as described in ISO 13320:2009. In particular, a Mastersizer 2000 instrument with a Hydro 2000G dispersion unit and the Mastersizer 2000 software from Malvern Instruments GmbH (Germany) is used. Isopropanol, for example, is suitable as the measuring medium. Preferably, a particle size of non-spherical or irregular particles is represented by the equivalent spherical diameter of a sphere of equivalent volume. Throughout this invention, whenever a range of particle sizes is given, these particle sizes were measured by laser diffraction. The lower values of such ranges given for the particle size herein represent D10 values whereas the upper values of the ranges given for the particle size herein represent D90 values of the respective particle size distribution. In other words, the lower values of such ranges correspond to the particle size where only 10% of all particles have a lower particle size, whereas the upper values of such ranges correspond to the particle size where only 10% of all particles have a larger particle size. The average particle size corresponds in particular to the D50 value (50% of the particles are smaller than the given value, 50% are correspondingly bigger). Also, whenever a particle size Dxx (with xx being any number between 0 and 100) is given, such particle size was determined by laser diffraction.

A measure for the fineness of a mineral materials, especially limestone, is the Blaine surface. The Blaine surface can be determined according to standard EN 196-6.

Typically, the mineral material, especially limestone, which is put to dry grinding consists of particles of irregular shape and size. A step of crushing big pieces of mineral materials, especially limestone, can be applied before subjecting said mineral materials, especially limestone, to dry grinding. Big pieces can be pieces of stone with an approximate diameter of more than 100 mm and up to several meters. Crushing of such bis pieces can be done for example in a jaw crusher. Preferably, the particle size D90 of a mineral material, especially limestone, prior to dry grinding is equal to or smaller than 100 mm.

The term “dry grinding” within the present context refers to a grinding operation where there is a low content of water present or better essentially no water present. A low content of water means that the water content during the grinding of mineral materials, especially limestone, is below 10 w %, preferably below 1 w %, more preferably below 0.1 w %, still more preferably equal to or below 0.06 w %, in each case relative to the total weight of the mineral materials, especially limestone. According to embodiments, the amount of water present during grinding is not higher than 10 w %, preferably 1 w %, more preferably 0.1 w %, still more preferably 0.06 w %, relative to the total dry weight of the mineral material, especially limestone.

The grinding additive is selected from the group consisting of alkanolamines, glycols, glycerol, sugars, sugar acids, carboxylic acids or their salts, superplasticizers, superabsorbent polymers, or mixtures thereof.

Suitable alkanolamines are preferably selected from the group consisting of monoethanolamine, diethanolamine, triethanolamine (TEA), diethanolisopropanolamine (DEIPA), ethanoldiisopropanolamine (EDIPA), isopropanolamine, diisopropanolamine, triisopropanolamine (TIPA), N-methyldiisopropanolamine (MDIPA), N-methyldiethanolamine (MDEA), tetrahydroxyethylethylenediamine (THEED), and tetrahydroxyiso-propylethylenediamine (THIPD), as well as mixtures of two or more of these alkanolamines.

Preferred alkanolamines are TIPA, MDIPA, MDEA, DEIPA, EDIPA, THEED, and THIPD, an especially preferred alkanolamine is MDEA.

According to preferred embodiments of the present invention, the grinding additive comprises or essentially consists of N-methyldiethanolamine (MDEA).

Examples of suitable glycols are monoethylene glycol, diethylene glycol, triethylene glycol, tetraethylene glycol, pentaethylene glycol, polyethylene glycol, in particular with 6 or more ethylene units, e.g. PEG 200, neopentyl glycol, hexylene glycol, propylene glycol, dipropylene glycol and polypropylene glycol. It is also possible to use mixtures of two or more different glycols as well as of at least one glycol and glycerine.

The terms “glycerol” and “glycerine” are used as synonyms throughout this invention. The terms “glycerol” and “glycerine” especially both stand for propane-1,2,3-triol. In one embodiment, the glycerol is a so-called bio-glycerine, which can be produced from a renewable raw material.

According to preferred embodiments of the present invention, the grinding additive comprises or essentially consists of diethylene glycol.

According to preferred embodiments of the present invention, the grinding additive comprises or essentially consists of glycerol.

A “sugar” in the sense of the present invention is a carbohydrate having an aldehyde group. In particularly preferred embodiments, the sugar belongs to the group of monosaccharides or disaccharides. Examples of sugars include, but are not limited to, glyceraldehyde, threose, erythrose, xylose, lyxose, ribose, arabinose, allose, altrose, glucose, mannose, gulose, idose, galactose, tallose, fructose, sorbose, lactose, maltose, sucrose, lactulose, trehalose, cellobiose, chitobiose, isomaltose, palatinose, mannobiose, raffinose and xylobiose. Sugars can also be used in form of e.g. vinasse, molasse.

A “sugar acid” in the context of the present invention is a monosaccharide having a carboxyl group. It may belong to any of the classes of aldonic acids, ursonic acids, uronic acids or aldaric acids. Preferably, it is an aldonic acid. Examples of sugar acids useful in connection with the present invention include, but are not limited to, glyceric acid, xylonic acid, gluconic acid, ascorbic acid, neuraminic acid, glucuronic acid, galacturonic acid, iduronic acid, tartaric acid, mucilic acid and saccharic acid. The sugar acid may be in the form of the free acid or as a salt. According to embodiments, salts of sugar acids may be salts with metals of groups Ia, IIa, Ib, IIb, IVb, VIIIb of the periodic table of elements. Preferred salts of sugar acids are salts of alkali metals, alkaline earth metals, iron, cobalt, copper, or zinc. Especially preferred are salts with monovalent metals such as lithium, sodium, and potassium.

The term “carboxylic acid” means any organic molecule with a carboxylate group, except sugar acids. Especially preferred carboxylic acids are oxalic acid, malonic acid, adipic acid, lactic acid, citric acid, and tartaric acid. The carboxylic acid may be in the form of the free acid or in the form of a salt. According to embodiments, salts of carboxylic acids may be salts with metals of groups Ia, IIa, Ib, IIb, IVb, VIIIb of the periodic table of elements. Preferred salts of sugar acids are salts of alkali metals, alkaline earth metals, iron, cobalt, copper, or zinc. Especially preferred are calcium salts of carboxylic acids.

The term “superabsorbent polymers” refers to polymers that can absorb large amounts of water. When superabsorbent polymers come into contact with water, the water molecules diffuse into the cavities of the polymer network and hydrate the polymer chains. The polymer can thus swell and form a polymer gel or slowly dissolve. This step is reversible, so the superabsorbent polymers can be regenerated to their solid state by removing the water. The water absorption property is denoted by the swelling ratio, by which is meant the ratio of the weight of a swollen superabsorbent polymer to its weight in the dried state. The swelling ratio is influenced by the degree of branching of the superabsorbent polymer, any crosslinking that may be present, the chemical structure of the monomers that form the superabsorbent polymer network, and external factors such as the pH, ion concentration of the solution, and temperature. Because of their ability to interact with water, superabsorbent polymers are also referred to as hydrogels.

Examples of superabsorbent polymers useful in the context of the present invention include but are not limited to natural polymers, such as starch, cellulose, such as cellulose ether, chitosan or collagen, alginates, synthetic polymers, such as poly(hydroxyethyl methacrylate), poly(ethylene glycol) or poly(ethylene oxide) or ionic synthetic polymers, such as polyacrylic acid (PAA), polymethacrylic acid (PMAA), polyacrylamides (PAM), polylactic acid (PLA), polyethyleneimine, polyvinyl alcohol (PVA) or polyvinylpyrrolidone.

Superabsorbent polymers that are particularly suitable in the context of the present invention are ionic superabsorbent polymers, in particular those based on polyacrylamide modified with acrylic acid, which can be of either linear or crosslinked structure.

Superplasticizers useful as grinding additives especially are polycarboxylate ether and/or polycarboxylate ester (PCE).

PCEs of the present invention comprise
(i) Repeating units A of the general structure (I),

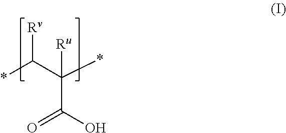

and
(ii) repeat units B of the general structure (II),

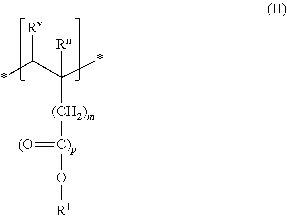

wherein
each Ru independently represents hydrogen or a methyl group,
each Rv independently represents hydrogen or COOM, wherein M independently is
H, an alkali metal, or an alkaline earth metal,
m=0, 1, 2 or 3,
p=0 or 1
each R1 is independently-(CH2) z-[YO]n-R4, where Y is a C2 to C4 alkylene and R4 is H, C1 to C20 alkyl, -cyclohexyl, -alkylaryl, or a —N(-Ri)j-[(CH2)z-PO3M]3-j, z=0, 1, 2, 3, or 4 n=2-350, j=0, 1 or 2, Ri represents a hydrogen atom or an alkyl group having 1-4 carbon atoms, and M represents a hydrogen atom, an alkali metal, an alkaline earth metal or an ammonium ion,
and wherein the repeating units A and B in the PCE have a molar ratio of A:B in the range of 10:90-90:10.

In a preferred embodiment, n=10-250, more preferably 30-200, particularly preferably 35-200, especially 40-110.

In a further preferred embodiment, z=0. In a further preferred embodiment, z=4.

In a particularly preferred embodiment, the PCE comprises repeating units A of the general structure (I) as well as repeating units B of the general structure (II), the molar ratios of A to B being in the range of 20:80-80:20, more preferably 30:70-80:20, in particular 35:65-75:25.

A PCE preferably has an average molar mass Mw in the range of 1,000-1,000,000, more preferably 1,500-500,000, most preferably 2,000-100,000, in particular 3,000-75,000 or 3,000-50,000 g/mol. The molar mass Mw is determined in the present case by gel permeation chromatography (GPC) with polyethylene glycol (PEG) as standard. This technique is known per se to the skilled person.

PCEs according to the invention can be random or non-random copolymers. Non-statistical copolymers are in particular alternating copolymers or block or gradient copolymers or mixtures thereof.

According to embodiments, the grinding additive of the present invention comprises N-methyldiethanolamine (MDEA). According to one particularly preferred embodiment, the grinding additive essentially consists of N-methyldiethanolamine (MDEA). It is, however, also possible that the grinding additive essentially consists of N-methyldiethanolamine (MDEA) in a solvent, especially water.

According to further embodiments, the grinding additive of the present invention comprises N-methyldiethanolamine (MDEA) and at least one further grinding additive selected from alkanolamines, glycols, glycerol, sugars, sugar acids, carboxylic acids or their salts, superplasticizers, and superabsorbent polymers. Within this context alkanolamines preferably are selected from the group consisting of monoethanolamine, diethanolamine, triethanolamine (TEA), diethanolisopropanolamine (DEIPA), ethanoldiisopropanolamine (EDIPA), isopropanolamine, diisopropanolamine, triisopropanolamine (TIPA), N-methyldiisopropanolamine (MDIPA), N-methyldiethanolamine (MDEA), tetrahydroxyethylethylenediamine (THEED), and tetrahydroxyiso-propylethylenediamine (THIPD). Glycols, glycerol, sugars, sugar acids, carboxylic acids or their salts, superplasticizers, and superabsorbent polymers are as described above.

According to embodiments, a grinding additive of the present invention may additionally comprise a defoamer. Examples of suitable defoamers are mineral or vegetable oils, fatty acids, fatty acid esters, fatty alcohols, alkoxylated fatty acids, alkoxylated fatty alcohols, polyalkylene glycol derivatives comprising units of propylene glycol and/or butylene glycol, acetylenic compounds, organo-silicone compounds, and organic phosphate esters.

Preferably, the defoamer is an organic phosphate ester, especially triisobutyl phosphate (TiBP) or tributyl phosphate (TBP).

It is for example possible for a grinding additive of the present invention to comprise N-methyldiethanolamine (MDEA) and TEA and optionally water. The weight ratio of MDEA to TEA preferably is in the range of 10:1-1:10. It is likewise possible to combine three or more alkanolamines into a grinding additive of the present invention. It is for example possible for a grinding aid of the present invention to comprise or essentially consist of a mixture of N-methyldiethanolamine (MDEA), triethanolamine (TEA), and triisopropanolamine (TIPA).

A particularly preferred grinding additive of the present invention consists of N-methyldiethanolamine (MDEA), diethanolisopropanolamine (DEIPA), optionally a defoamer, and optionally water. The weight ratio of MDEA:DEIPA preferably is from 10:1 to 1:10, more preferably from 5:1 to 1:1, especially 2:1. The defoamer may be as described above.

An especially preferred grinding additive of the present invention consists of 1 mass part of N-methyldiethanolamine (MDEA), 0.5 mass parts of diethanolisopropanolamine (DEIPA), 0.01 mass parts of a defoamer, and 1 mass part of water. The defoamer may be as described above.

Another particularly preferred grinding additive of the present invention consists of N-methyldiethanolamine (MDEA), triethanolamine (TEA), acetic acid, optionally a defoamer, and optionally water. The weight ratio of MDEA:TEA preferably is from 10:1 to 1:10, more preferably from 5:1 to 1:1, especially 1.25:1. The defoamer may be as described above.

Another particularly preferred grinding additive of the present invention consists of N-methyldiethanolamine (MDEA), triethanolamine (TEA), and diethanolisopropanolamine (DEIPA), optionally water, and optionally a defoamer. The weight ratio of MDEA:TEA:DEIPA preferably is from 10-0.1:1:0.1-10. The defoamer, if present, may be as described above.

An especially preferred grinding additive of the present invention consists of 1 mass part of N-methyldiethanolamine (MDEA), 0.8 mass parts of triethanolamine (TEA), 0.1 mass parts of acetic acid, 0.01 mass parts of a defoamer, and 0.5 mass parts of water. The defoamer may be as described above.

A grinding additive of the present invention may be in the form of a mono-component or a multi-component composition. In a multi-component composition, components of the grinding additive are stored in at least two spatially separate receptables. It is generally preferred, within the present context, to use mono-component grinding additives.

According to embodiments, the grinding additive is added to the mineral material, especially limestone, prior to and/or during grinding in a total amount of between 0.001-3 w %, preferably 0.002-1 w %, more preferably 0.01-0.5 w %, in each case relative to the total dry weight of the mineral material, especially limestone.

It is preferred that fines and/or the powdery material are removed from the grinding zone during grinding. This increases the grinding efficiency. The removal preferably is done continuously, for example by blowing air through the grinding zone.

The method of the present invention may additionally comprise a step of separating the ground mineral materials, especially limestone, according to particle size. According to embodiments, separation is effected at a predefined cut-off particle size in order to retrieve ground mineral materials, especially limestone, with a particle size of at least the predefined cut-off particle size and/or in order to retrieve ground mineral materials, especially limestone, with a particle size below the predefined cut-off particle size. According to further embodiments, it is also possible to separate the ground mineral materials, especially limestone, into fractions of different particle size.

According to embodiments, separation is done by filtration, sieving, sedimentation, density separation, wind sifting, e.g. in cyclones, and/or centrifugation.

The method of the present invention can be done in a batch process or in a continuous process. Installations, especially grinders and mills, useful for the practice of the present invention are not particularly limited and are known per se. According to embodiments, the grinding is done in an attrition mill or a compressive grinder, especially in a ball mill or in a vertical roller mill or in a high pressure roller mill. However, other mill types such as for example hammer mills, pebble mills, cone mills, E-mills, or jaw crushers are likewise suitable.

According to embodiments, dry grinding of the mineral material, especially limestone, is done in a ball mill with steel balls of a diameter between 0.5-100 mm. A weight ratio of limestone:steel balls is between 1:10 and 20:1. The time for dry grinding may vary between 1 minute and 3 hours, preferably 5 minutes and 1 hour, especially 10-30 minutes.

In a second aspect the present invention relates to a ground mineral material, especially ground limestone, obtained by dry grinding a mineral material, especially limestone, in the presence of a grinding additive selected form the group consisting of alkanolamines, glycols, glycerol, sugars, sugar acids, carboxylic acids or their salts, superplasticizers, superabsorbent polymers, or mixtures thereof.

It is to be understood that all features and embodiments described above as being preferred also relate to the ground mineral material, especially ground limestone. In some embodiments, the present invention thus relates to a ground mineral material, especially ground limestone, obtained by dry grinding a mineral material, especially limestone, in the presence of a grinding additive comprising or essentially consisting of N-methyldiethanolamine (MDEA), diethylene glycol, or glycerol.

For example, the present invention relates to a ground mineral material, especially ground limestone, obtained by dry grinding a mineral material, especially limestone, in the presence of a grinding aid consisting of N-methyldiethanolamine (MDEA), diethanolisopropanolamine (DEIPA), optionally a defoamer, and optionally water. The weight ratio of MDEA:DEIPA preferably is from 10:1 to 1:10, more preferably from 5:1 to 1:1, especially 2:1.

For example, the present invention relates to a ground mineral material, especially ground limestone, obtained by dry grinding a mineral material, especially limestone, in the presence of a grinding aid consisting of 1 mass part of N-methyldiethanolamine (MDEA), 0.5 mass parts of diethanolisopropanolamine (DEIPA), 0.01 mass parts of a defoamer, and 1 mass part of water.

For example, the present invention relates to a ground mineral material, especially ground limestone, obtained by dry grinding a mineral material, especially limestone, in the presence of a grinding aid consisting of N-methyldiethanolamine (MDEA), triethanolamine (TEA), acetic acid, optionally a defoamer, and optionally water. The weight ratio of MDEA:TEA preferably is from 10:1 to 1:10, more preferably from 5:1 to 1:1, especially 1.25:1.

For example, the present invention relates to a ground mineral material, especially ground limestone, obtained by dry grinding a mineral material, especially limestone, in the presence of a grinding aid consisting of 1 mass part of N-methyldiethanolamine (MDEA), 0.8 mass parts of triethanolamine (TEA), 0.1 mass parts of acetic acid, 0.01 mass parts of a defoamer, and 0.5 mass parts of water.

For example, the present invention relates to a ground mineral material, especially ground limestone, obtained by dry grinding a mineral material, especially limestone, in the presence of a grinding aid consisting of diethylene glycol, optionally a defoamer, and optionally water.

For example, the present invention relates to a ground mineral material, especially ground limestone, obtained by dry grinding a mineral material, especially limestone, in the presence of a grinding aid consisting of glycerol, optionally a defoamer, and optionally water.

The defoamer in these examples can be any defoamer as described above.

It is preferred that the ground mineral materials, especially ground limestone, obtained as explained above has a Blaine surface which is higher than that of the mineral material, especially limestone, prior to grinding. Specifically, the Blaine surface is increased by more than 10%, preferably more than 50%, especially more than 100%.

According to embodiments, the ground mineral material, especially ground limestone, of the present invention has a Blaine surface of 2000-12000 cm²/g, preferably 3000-10000 cm²/g, more preferably 4000-9000 cm²/g, especially 6000-8000 cm²/g.

According to embodiments, the ground mineral materials, especially ground limestone, is characterized by a residue on a 45 μm sieve of not more than 25% and/or by a residue on a 32 μm sieve of not more than 45%, preferably not more than 35%.

According to embodiments, the ground mineral materials, especially ground limestone, is characterized by a particle size D50 of 0.4-1000 μm, preferably 1-500 μm, especially 2-63 μm.

In a third aspect the present invention relates to a construction material, especially a mortar or concrete, comprising a ground mineral material, especially ground limestone, as described above.

The ground mineral material, especially ground limestone, of the present invention is used in the construction material as part of the binder and/or as an aggregate. Preferably, the construction material of the present invention additionally comprises at least one mineral binder and optionally further aggregates. Preferably, the at least one mineral binder is selected from the group consisting of cement, gypsum, lime, latent hydraulic binders, pozzolanes, and geopolymers. Cements can in particular be Portland cements as described in standard EN 197-1, calcium aluminate cements as described in standard EN 14647, and/or calcium sulfoaluminate cements. The term “gypsum” is meant to encompass CaSO₄ in various forms, in particular CaSO₄ anhydrite, CaSO₄ α- and β-hemihydrate, and CaSO₄ dihydrate. The term “lime” is meant to encompass natural hydraulic lime, formulated lime, hydraulic lime, and air lime as described in the standard EN 459-1:2015. Pozzolanes and latent hydraulic materials preferably are selected from the group consisting of clay, calcined clay, especially metakaolin, kiln dust, microsilica, fly ash, zeolite, rice husk ash, blast furnace slag, burnt oil shale, and natural pozzolane such as pumice and trass. Geopolymers are alumo-siliceous polymers. One particular example of a geopolymer is furnace slag activated with water glass.

Construction materials within the present context optionally comprise further aggregates. Aggregates can be any material that is non-reactive in the hydration reaction of hydraulic binders. Aggregates can be any aggregate typically used for construction materials. Typical aggregates are for example rock, crushed stone, gravel, sand, especially quartz sand, river sand and/or manufactured sand, slag, recycled concrete, glass, expanded glass, hollow glass beads, glass ceramics, volcanic rock, pumice, perlite, vermiculite, quarry wastes, raw, fired or fused earth or clay, porcelain, electrofused or sintered abrasives, firing support, silica xerogels. Aggregates may also be fine aggregates or fillers. Aggregates useful for the present invention can have any shape and size typically encountered for such aggregates. An especially preferred aggregate is sand. Sand is a naturally occurring granular material composed of finely divided rock or mineral particles. It is available in various forms and sizes. Examples of suitable sands are quartz sand, river sand or crushed aggregates. Suitable sands are for example described in standards ASTM C778 or EN 196-1.

According to embodiments, aggregates can also be one or more of the following (i)-(v):
(i) biosourced materials, preferably of plant origin, more preferably biosourced materials of plant origin essentially composed of cellulose and/or lignin, especially biosourced materials selected from the group comprising or consisting of hemp, flax, cereal straw, oats, rice, rape, maize, sorghum, flax, miscanthus, rice husk, sugar cane, sunflower, kenaf, coconut, olive stones, bamboo, wood, or mixtures thereof. According to embodiments, biosourced materials of plant origin have a defined form which is preferably selected from fibres, fibrils, dust, powders, shavings, pith, in particular pith of sunflower, maize, rape, and mixtures thereof.
(ii) synthetic non-mineral materials, preferably selected from the group comprising or consisting of thermoplastic, thermosetting plastics, elastomers, rubbers, textiles fibers, plastic materials reinforced with glass or carbon fibres. Synthetic non-mineral materials can be filled or unfilled.
(iii) aggregates of inorganic nature from the deconstruction of civil engineering or building structures, preferably selected from the group comprising or consisting of waste concrete, mortar, bricks, natural stone, asphalt, tiles, tiling, aerated concrete, clinker, scrap metal.
(iv) aggregates of organic nature from the recycling of industrial products, in particular composite materials which are difficult to recycle, especially recycled insulating materials. Especially preferred examples are polystyrenes, polyurethanes, phenolic resins, wood insulating materials, and mixtures thereof.
(v) non-hazardous granular materials usually destined for landfill such as slag, especially ground granulated blast furnace slag or basic oxygen slag, used foundry sands, catalyst supports, Bayer process de-soding treatment supports, clinker aggregates, fillers from the treatment of excavation sludge, sewage sludge, slurry, paper waste, paper incineration ashes, household waste incineration ashes.

Most preferably, aggregates are in particulate form.

Optionally, a construction material of the present invention may additionally comprise at least one further additive selected from the group consisting of plasticizers, superplasticizers, shrinkage reducers, air entrainers, de-aerating agents, stabilizers, viscosity modifiers, water reducers, accelerators, retarders, water resisting agents, strength enhancing additives, fibers, blowing agents, defoamers, redispersible polymer powders, chromate reducers, pigments, and steel passivating agents.

A construction material of the present invention can be in a dry state. Typically, dry construction materials are in the form of powders. A dry construction material can especially be a dry mortar or a dry concrete. Dry construction materials preferably have a water content of not more than 5 w %, more preferably not more than 2 w %, especially not more than 1 w %, in each case relative to the total weight of binder present in the dry construction material.

A construction material of the present invention can also be in the wet state. Typically, wet construction materials are in the form of slurries in water. A wet construction material can especially be a dry mortar or dry concrete mixed with water. Wet construction materials preferably have a mass ratio of water:mineral binder between 0.1-0.8, preferably 0.25-0.6, especially 0.3-0.5.

A construction material of the present invention can also be in the hardened state. Hardening of a dry construction material of the present invention starts when water is added. Upon hardening the construction material attains its final strength. A hardened construction material can have any desired form. A hardened construction material can be a building or be part of a building.

Especially, a construction material can be a dry concrete or a dry mortar.

A construction material of the present invention comprises or consists of (in each case relative to the total dry mass of the construction material)
a) 1-99 w % of a ground mineral material, especially ground limestone, as described above;
b) 1-99 w % of at least one mineral binder, preferably selected from the group consisting of cement, gypsum, lime, latent hydraulic binders, pozzolanes, and geopolymers;
c) optionally 15-85 w % of aggregates;
d) optionally 0.1-10 w % of at least one further additive; and
e) optionally water in an amount to realize a mass ratio of water:mineral binder between 0.1-0.8, preferably 0.25-0.6, especially 0.3-0.5.

According to embodiments, a construction material of the present invention comprises (in each case relative to the total dry mass of the construction material)
a) 5-75 w %, preferably 6-20 w % or 25-75 w % of a ground mineral material, especially ground limestone, as described above;
b) 1-75 w %, preferably 5-50 w % of at least one mineral binder, preferably selected from the group consisting of cement, gypsum, lime, latent hydraulic binders, pozzolanes, and geopolymers;
c) 15-85 w % of aggregates;
d) optionally 0.1-10 w % of at least one further additive; and
e) optionally water in an amount to realize a mass ratio of water:mineral binder between 0.1-0.8, preferably 0.25-0.6, especially 0.3-0.5.

According to further embodiments, a construction material of the present invention consists of (in each case relative to the total dry mass of the construction material)
a) 5-75 w %, preferably 6-20 w % or 25-75 w % of a ground mineral material, especially ground limestone, as described above;
b) 1-75 w %, preferably 5-50 w % of at least one mineral binder, preferably selected from the group consisting of cement, gypsum, lime, latent hydraulic binders, pozzolanes, and geopolymers;
c) 15-85 w % of aggregates;
d) optionally 0.1-10 w % of at least one further additive; and
e) optionally water in an amount to realize a mass ratio of water:mineral binder between 0.1-0.8, preferably 0.25-0.6, especially 0.3-0.5.

According to further embodiments, a construction material of the present invention comprises (in each case relative to the total dry mass of the construction material)
a) 5-75 w %, preferably 6-20 w % or 25-75 w % of a ground mineral material, especially ground limestone, as described above;
b) 1-75 w %, preferably 5-50 w % of Portland cement;
c) 15-85 w % of aggregates;
d) optionally 0.1-10 w % of at least one further additive; and
e) optionally water in an amount to realize a mass ratio of water:mineral binder between 0.1-0.8, preferably 0.25-0.6, especially 0.3-0.5.

A ground limestone of the present invention can also be used to manufacture cements of type CEM II/A-L, CEM II/A-LL, CEM II/B-L, CEM II/B-LL and CEM II/X-M (Y-L or LL), whereas X can be A, B or C and Y can be one or more of S, D, P, Q, V, W, T according to standard EN 197-1. The ground limestone of the present invention is mixed or interground with Portland cement clinker to prepare any of these cements. Cements of type CEM II/A-L, CEM II/A-LL, CEM II/B-L, and CEM II/B-LL, and CEM II/X-M (Y-L or LL), whereas X can be A, B or C and Y can be one or more of S, D, P, Q, V, W, T according to standard EN 197-1 and comprising a ground limestone of the present invention show improved development of compressive strength. The present invention thus also relates to a cement of type CEM II/A-L, CEM II/A-LL, CEM II/B-L, and CEM II/B-LL, and CEM II/X-M (Y-L or LL), whereas X can be A, B or C and Y can be one or more of S, D, P, Q, V, W, T according to standard EN 197-1, characterized in that said cement comprises ground limestone according to the present invention. The present invention also relates to a method of manufacturing a cement of type CEM II/A-L, CEM II/A-LL, CEM II/B-L, and CEM II/B-LL, and CEM II/X-M (Y-L or LL), whereas X can be A, B or C and Y can be one or more of S, D, P, Q, V, W, T according to standard EN 197-1, characterized in that said method comprises a step of mixing or intergrinding Portland cement clinker with a ground limestone of the present invention.

In a fourth aspect the present invention relates to a method to increase the efficiency of the dry grinding of mineral materials, especially limestone, characterized in that the mineral material, especially limestone, is dry ground together with a grinding additive comprising or essentially consisting of N-methyldiethanolamine (MDEA), diethylene glycol, or glycerol and that the grinding additive is added to the mineral material, especially limestone, prior to and/or during grinding.

An increase in dry grinding efficiency is for example a shorter grinding time needed to obtain a given Blaine surface of the ground mineral material, especially ground limestone. The Blaine surface can be measured as described above. An increase in dry grinding efficiency for example also is a lower amount of material sticking to parts of the mill during and after the grinding.

For example, the grinding additive used in a method to increase the efficiency of the dry grinding of mineral materials, especially limestone consists of N-methyldiethanolamine (MDEA), diethanolisopropanolamine (DEIPA), optionally a defoamer, and optionally water. The weight ratio of MDEA:DEIPA preferably is from 10:1 to 1:10, more preferably from 5:1 to 1:1, especially 2:1.

For example, the grinding additive used in a method to increase the efficiency of the dry grinding of mineral materials, especially limestone consists of 1 mass part of N-methyldiethanolamine (MDEA), 0.5 mass parts of diethanolisopropanolamine (DEIPA), 0.01 mass parts of a defoamer, and 1 mass part of water.

For example, the grinding additive used in a method to increase the efficiency of the dry grinding of mineral materials, especially limestone consists of N-methyldiethanolamine (MDEA), triethanolamine (TEA), acetic acid, optionally a defoamer, and optionally water. The weight ratio of MDEA:TEA preferably is from 10:1 to 1:10, more preferably from 5:1 to 1:1, especially 1.25:1.

For example, the grinding additive used in a method to increase the efficiency of the dry grinding of mineral materials, especially limestone consists of 1 mass part of N-methyldiethanolamine (MDEA), 0.8 mass parts of triethanolamine (TEA), 0.1 mass parts of acetic acid, 0.01 mass parts of a defoamer, and 0.5 mass parts of water.

For example, the grinding additive used in a method to increase the efficiency of the dry grinding of mineral materials, especially limestone, consists of diethylene glycol, optionally a defoamer, and optionally water.

For example, the grinding additive used in a method to increase the efficiency of the dry grinding of mineral materials, especially limestone consists of glycerol, optionally a defoamer, and optionally water.

The defoamer in these examples can be any defoamer as described above.

In a fifth aspect the present invention relates to a method to increase the early strength of a cementitious material said method comprising a step of adding a ground mineral material, especially a ground limestone, to said cementitious material, characterized in that a grinding additive comprising or essentially consisting of N-methyldiethanolamine (MDEA) is added to said mineral material, especially limestone, prior to and/or during the grinding thereof. There is no step of completely extracting the grinding additive from the ground mineral material, especially ground limestone, after the dry grinding.

For example, the grinding additive used in a method to increase the early strength of a cementitious material, consists of N-methyldiethanolamine (MDEA), diethanolisopropanolamine (DEIPA), optionally a defoamer, and optionally water. The weight ratio of MDEA:DEIPA preferably is from 10:1 to 1:10, more preferably from 5:1 to 1:1, especially 2:1.

For example, the grinding additive used in a method to increase the early strength of a cementitious material consists of 1 mass part of N-methyldiethanolamine (MDEA), 0.5 mass parts of diethanolisopropanolamine (DEIPA), 0.01 mass parts of a defoamer, and 1 mass part of water.

For example, the grinding additive used in a method to increase the early strength of a cementitious material consists of N-methyldiethanolamine (MDEA), triethanolamine (TEA), acetic acid, optionally a defoamer, and optionally water. The weight ratio of MDEA:TEA preferably is from 10:1 to 1:10, more preferably from 5:1 to 1:1, especially 1.25:1.

For example, the grinding additive used in a method to increase the early strength of a cementitious material consists of 1 mass part of N-methyldiethanolamine (MDEA), 0.8 mass parts of triethanolamine (TEA), 0.1 mass parts of acetic acid, 0.01 mass parts of a defoamer, and 0.5 mass parts of water.

For example, the grinding additive used in a method to increase the early strength of a cementitious material consists of diethylene glycol, optionally a defoamer, and optionally water.

For example, the grinding additive used in a method to increase the early strength of a cementitious material consists of glycerol, optionally a defoamer, and optionally water.

The defoamer in these examples can be any defoamer as described above.

The early strength relates to the compressive strength and/or flexural strength of a construction material after hardening for not more than 7 days, preferably after hardening for 1 day, 2 days, and/or 3 days. Compressive strength can be measured according to standard EN 12190 on 4×4×16 cm prisms. Flexural strength can be measured according to standard EN 196-1 on prisms 40×40×160 mm.

In particular, the early strength of a construction material comprising a ground mineral materials, especially ground limestone, of the present invention is improved over the same construction material but comprising a ground mineral materials, especially ground limestone, with the same Blaine surface and/or particle size and ground without the addition of an additive of the present invention.

### EXAMPLES

In the following examples:
Limestone 1 or limestone 2 were used respectively. Limestone 1 has a particle size D90 of 100 mm and a Mohs hardness of appr. 3. Limestone 2 has a particle size D90 of 100 mm and a Mohs hardness of appr. 4. Limestone was used as received and e.g. not dried before grinding.
N-methyldiethanolamine (MDEA) used was purchased from Sigma-Aldrich with a purity of >99%
Triethanolamine (TEA) used was purchased from Sigma-Aldrich with a purity of 98%
Triisopropanolamine (TIPA) used was purchased from Sigma-Aldrich with a purity of 95%
Diethylene glycol (DEG) used was purchased from Sigma-Aldrich with a purity of 99%
Glycerine used was purchased from Sigma-Aldrich with a purity of >99.5%
Compressive strength was measured on prisms of 40×40×160 mm according to standard EN 196-1:2016.
Blaine surface was measured according to standard EN 196-6:2010.
Sieve residue was measured according to standard ASTM C136/C136M on a 32 μm sieve. The amount of material retained on this sieve is reported in w % relative to the total weight of ground material.

### Example 1

40 g of limestone 1 were charged into a ball mill. 260 g of steel balls with a diameter of 100 mm were added. Then the respective grinding aids as shown in table 1 were added in an amount of 0.02 w % relative to the weight of the limestone. Grinding was then done for the time indicated in table 1. After this time, a sample was taken for the analysis of Blaine surface and sieve residue.

The following table 1 gives an overview of the results. Example 1-1 is a comparative example not according to the invention. Examples 1-2 and 1-3 are according to the present invention.

TABLE 1
examples 1-1 to 1-3

| Example | 1-1 | 1-2 | 1-3 |
|---|---|---|---|
| Grinding aid | none | MDEA | MDEA |
| Grinding time [s] | 240 | 240 | 190 |
| Blaine surface [cm²/g] | 4265 | 4860 | 4310 |
| Sieve residue 32 μm | 38.0 | 33.9 | 37.5 |
| [w %] | | | |

It can be seen from the results of table 1, that the use of N-methyldiethanolamine (MDEA) during grinding of limestone is effective in increasing the fineness. This can be seen by an increase in Blaine surface and a reduction of sieve residue 32 μm when grinding limestone with MDEA as compared to grinding limestone without MDEA for the same time (cf 1-1 and 1-2). It can also be seen that the grinding time may be reduced to retrieve a limestone powder of a given fineness when MDEA is added as compared to grinding a limestone without MDEA added (cf 1-1 and 1-3).

### Example 2

Hydraulic binders were prepared using the ground limestone obtained in examples 1-1 and 1-3. Hydraulic binders were obtained by vigorously mixing 65 w % of ground cement clinker (consisting of 95 w % Portland cement clinker and 5 w % of sulfate carrier), 20 w % of ground granulated blast furnace slag, and 15 w % of the respective ground limestone of examples 1-1 or 1-3 until visually homogeneous. Ground cement clinker and ground granulated blast furnace slag both had a Blaine surface of 4000-4500 cm²/g.

Mortars were prepared using these binders in accordance with standard EN 196-1:2016. 450 g of the respective hydraulic binder and 225 g of water were weighed into the mixer and mixed at low speed. 1350 g of sand were added after an initial mixing time of 30 s over the course of 30 s. Then mixing speed was increased and mixing continued for another 30 s. The mixer was then stopped and the paste formed was scraped down. After 90 s, mixing was resumed at high speed for another 60 s.

Compressive strength was measured after the times indicated in table 2.

The following table 2 gives an overview of the results. Example 2-1 is a comparative example not according to the invention. Example 2-2 is according to the present invention.

TABLE 2
examples 2-1 and 2-2

| Example | 2-1 | 2-2 |
|---|---|---|
| Limestone powder from example [. . .] | 1-1 | 1-3 |
| used for hydraulic binder | | |
| Compressive strength @ 1 d [MPa] | 16.3 | 19.9 |
| Compressive strength @ 2 d [MPa] | 28.3 | 30.8 |
| Compressive strength @ 7 d [MPa] | 46.6 | 49.6 |
| Compressive strength @ 28 d [MPa] | 62.2 | 66.9 |

It can be seen from the results of table 2 that the use of a limestone with MDEA added during grinding thereof leads to mortars with an increased compressive strength at all ages as compared to the use of limestone without MDEA.

### Example 3

40 g of limestone 2 were charged into a ball mill. 260 g of steel balls with a diameter of 100 mm were added. Then the respective grinding aids as shown in table 3 were added in an amount of 0.01 w % relative to the weight of the limestone. Grinding was then done for 4 minutes. After this time, a sample was taken for the analysis of Blaine surface and sieve residue.

The following table 3 gives an overview of the results. Example 3-1 is a comparative example not according to the invention. Examples 3-2 to 3-6 are according to the present invention.

TABLE 3
examples 3-1 to 3-6

| Example | 3-1 | 3-2 | 3-3 | 3-4 | 3-5 | 3-6 |
|---|---|---|---|---|---|---|
| Grinding aid | none | MDEA | TEA | TIPA | DEG | glyc- |
| | | | | | | erine |
| Blaine surface | 3145 | 3885 | 3690 | 3800 | 3625 | 3525 |
| [cm²/g] | | | | | | |
| Sieve residue | 42.3 | 34.8 | 37.2 | 35.2 | 36.3 | 37.8 |
| 32 μm [w %] | | | | | | |

It can be seen from the results of table 3, that the use of any of MDEA, TEA, TIPA, DEG, and glycerine during grinding of limestone is effective in increasing the fineness. This can be seen by an increase in Blaine surface and a reduction of sieve residue 32 μm when grinding limestone with any of MDEA, TEA, TIPA, DEG, and glycerine as compared to grinding limestone without MDEA for the same time. It may also be seen that N-methyldiethanolamine (MDEA) is particularly effective in increasing the fineness of a limestone during grinding (cf 3-2 vs and of 3-3 to 3-6).

### Example 4

Hydraulic binders were prepared using the ground limestone obtained in examples 3-1 to 3-6. Hydraulic binders were obtained by vigorously mixing 65 w % of ground cement clinker (consisting of 95 w % Portland cement clinker and 5 w % of sulfate carrier), 20 w % of ground granulated blast furnace slag, and 15 w % of the respective ground limestone of examples 3-1 to 3-6 until visually homogeneous. Ground cement clinker and ground granulated blast furnace slag both had a Blaine surface of 3500-4000 cm²/g.

Mortars were prepared using these binders in accordance with standard EN 196-1:2016. 450 g of the respective hydraulic binder and 225 g of water were weighed into the mixer and mixed at low speed. 1350 g of sand were added after an initial mixing time of 30 s over the course of 30 s. Then mixing speed was increased and mixing continued for another 30 s. The mixer was then stopped and the paste formed was scraped down. After 90 s, mixing was resumed at high speed for another 60 s.

Compressive strength was measured after the times indicated in table 4.

The following table 2 gives an overview of the results. Example 2-1 is a comparative example not according to the invention. Example 2-2 is according to the present invention.

TABLE 4
examples 2-1 and 2-2

| Example | 4-1 | 4-2 | 4-3 | 4-4 | 4-5 | 4-6 |
|---|---|---|---|---|---|---|
| Limestone powder from example [. . .] | 3-1 | 3-2 | 3-3 | 3-4 | 3-5 | 3-6 |
| used for hydraulic binder | | | | | | |
| Compressive strength @ 1 d [MPa] | 14.4 | 14.9 | 14.8 | 15.8 | 16.5 | 18.0 |

It can be seen from the results of table 4 that the use of a limestone with any of MDEA, TEA, TIPA, DEG, and glycerine added during grinding thereof leads to mortars with an increased early compressive strength as compared to the use of limestone without any of MDEA, TEA, TIPA, DEG, and glycerine.

1. A method comprising:
dry grinding mineral materials; and
adding a grinding additive during the dry grinding of the mineral materials, wherein the grinding additive is selected from the group consisting of alkanolamines, glycols, glycerol, sugars, sugar acids, carboxylic acids or their salts, superplasticizers, superabsorbent polymers, or mixtures thereof.

2. The method according to claim 1, wherein the grinding additive comprises or essentially consists of N-methyldiethanolamine (MDEA).

3. The method according to claim 1, wherein the grinding additive comprises or essentially consists of diethylene glycol.

4. The method according to claim 1, wherein the grinding additive comprises or essentially consists of glycerol.

5. The method according to claim 1, wherein the amount of water present during grinding is not higher than 10 w %, relative to the total dry weight of the mineral material.

6. The method as claimed in claim 1, wherein the grinding additive is added to the mineral material prior to and/or during grinding in a total amount of between 0.001-3 w %, relative to the total dry weight of the mineral material.

7. The method as claimed in claim 1, wherein the grinding is done in an attrition mill or a compressive grinder.

8. A ground mineral material obtained by dry grinding a mineral material in the presence of a grinding additive selected form the group consisting of alkanolamines, glycols, glycerol, sugars, sugar acids, carboxylic acids or their salts, superplasticizers, superabsorbent polymers, or mixtures thereof.

9. A ground mineral material according to claim 8, wherein the grinding additive comprises or essentially consists of N-methyldiethanolamine (MDEA), diethylene glycol, or glycerol.

10. Construction material comprising a ground mineral material as claimed in claim 8.

11. A construction material as claimed in claim 10 comprising or consisting of
(in each case relative to the total dry mass of the construction material)
a) 1-99 w % of the ground mineral material;
b) 1-99 w % of at least one mineral binder, selected from the group consisting of cement, gypsum, lime, latent hydraulic binders, pozzolanes, and geopolymers;
c) optionally 15-85 w % of aggregates;
d) optionally 0.1-10 w % of at least one further additive; and
e) optionally water in an amount to realize a mass ratio of water:mineral binder between 0.1-0.8.

12. A cement of type CEM II/A-L, CEM II/A-LL, CEM II/B-L, CEM II/B-LL, and CEM II/X-M (Y-L or LL), whereas X can be A, B or C and Y can be one or more of S, D, P, Q, V, W, T according to standard EN 197-1, wherein the cement comprises ground limestone as claimed in claim 8.

13. A method to increase the efficiency of the dry grinding of a mineral material, wherein the mineral material is dry ground together with a grinding additive comprising or essentially consisting of N-methyldiethanolamine (MDEA) and wherein the grinding additive is added to the mineral material prior to and/or during grinding.

14. A method to increase the early strength of a cementitious material the method comprising a step of adding a ground mineral material to the cementitious material, wherein a grinding additive comprising or essentially consisting of N-methyldiethanolamine (MDEA) is added to the mineral material prior to and/or during the grinding thereof.
